(19) United States
(12) Patent Application Publication
(10) Pub. No.: US 2026/0186445 A1
(43) Pub. Date: Jul. 2, 2026

(54) CONDUCTIVE COMPONENT, PROCESS CARTRIDGE, AND IMAGE FORMING APPARATUS

(71) Applicant: Zhuhai Pantum Electronics Co., Ltd., Zhuhai (CN)

(72) Inventors: Shujia HOU, Zhuhai (CN); Xining DING, Zhuhai (CN)

(21) Appl. No.: 19/434,706

(22) Filed: Dec. 29, 2025

(30) Foreign Application Priority Data
Dec. 31, 2024 (CN) 2024120001138

(51) Int. Cl. G03G 21/18; G03G 15/00

(52) U.S. Cl. CPC G03G 21/1871; G03G 15/80; G03G 21/1814; G03G 21/1878; G03G 2221/1654

(57) ABSTRACT

The present application relates to the field of image forming technology, and in particular, provides a conductive component, a process cartridge, and an image forming apparatus. The conductive component includes the conductive members which include the electrical contacts; at least two of the electrical contacts have different first projection lengths in a second direction; the first projection length is the length between a first projection position which is the projection position of the electrical contact in the second direction and a second projection position which is the projection position of a first reference position in the second direction; the first reference position is any point on a side of the conductive component away from the electrical contacts; an installation direction of the process cartridge is a first direction, the second direction is arranged intersecting the first direction, the second direction is parallel to an axial direction of a roller member.

This application claims the priority to Chinese Patent Application No. 202412000113.8, filed on Dec. 31, 2024, which is incorporated herein by reference in its entirety.

### TECHNICAL FIELD

The present application relates to the field of image forming technology, and in particular, to a conductive component, a process cartridge, and an image forming apparatus.

### BACKGROUND

In related art, it is necessary to set up additional positioning members to perform installation positioning for the conductive component, so that the conductive members of the conductive component can align with the power supply members. If the positioning members are improperly set, it may cause the conductive members to fail to align as required, thereby affecting conductive performance and stability; moreover, additionally configuring positioning members also incurs certain cost issues.

### SUMMARY

The present application is proposed in view of the above problems. The present application provides a conductive component, a process cartridge, and an image forming apparatus.

According to one aspect of the present application, a conductive component is provided, the conductive component is configured to be disposed on a process cartridge or an image forming apparatus, the process cartridge is detachably installable into a body of the image forming apparatus, and an installation direction of the process cartridge is a first direction. The conductive component includes: a plurality of conductive members, the conductive members are configured to achieve electrical connection between a power supply member of the image forming apparatus and a load member of the process cartridge, and at least one of the load members include a roller member; the conductive members include a electrical contact, and the electrical contact is configured to contact the power supply member to connect to a power source; wherein at least two of the plurality of electrical contacts have different first projection lengths in a second direction; the first projection length is a length between a first projection position and a second projection position; the first projection position is a projection position of the electrical contact in the second direction; the second projection position is a projection position of a first reference position in the second direction; the first reference position is any point on a side of the conductive component away from the electrical contacts; wherein the second direction intersects the first direction, and the second direction is parallel to an axial direction of the roller member.

According to another aspect of the present application, a process cartridge is provided, which includes: a cartridge body; at least one of the load members which includes a roller member, and the roller member is rotatably disposed on the cartridge body; a conductive component which includes: a plurality of conductive members which are configured to achieve electrical connection between a power supply member of the image forming apparatus and the load member; the conductive member includes a electrical contact which is configured to contact the power supply member to connect to a power source; wherein at least two of the plurality of electrical contacts have different first projection lengths in a second direction; the first projection length is a length between a first projection position and a second projection position; the first projection position is a projection position of the electrical contact in the second direction; the second projection position is a projection position of a first reference position in the second direction; the first reference position is any point on a side of the conductive component away from the electrical contacts; wherein the second direction intersects the first direction, and the second direction is parallel to an axial direction of the roller member.

According to another aspect of the present application, an image forming apparatus is provided, which includes: a body which includes an inner side plate, and the inner side plate is provided with a guide groove; a plurality of power supply members; wherein at least two of contact portions of the plurality of power supply members have different first projection lengths formed in a second direction, and sequentially increase along a first direction; the first direction is parallel to an extension direction of the guide groove, and the second direction intersects a plane where the inner side plate is located; wherein the guide groove is configured to guide an installation direction of a conductive component or a process cartridge.

As will be described in detail below, according to embodiments of the present application, a conductive component, a process cartridge, and an image forming apparatus are provided. In the present application, the first direction is the installation direction of the process cartridge, and the second direction is parallel to the axial direction of the roller member. On this basis, by designing at least two of the plurality of electrical contacts to have different first projection lengths in the second direction, at least two conductive members can have different lengths in the axial direction of the roller member. Thus, by matching the lengths of the conductive members with the image forming apparatus, precise positioning and matching between the conductive members and the power supply members can be achieved. Therefore, while satisfying the requirement for the electrical contacts to contact the power supply members for conduction, the length of the conductive members themselves in the second direction, which needs to be provided anyway, is utilized to assist in achieving positioning matching. This not only provides good conductive performance and stability but also allows omission of positioning members or eliminates special precision requirements and costs for positioning members in some embodiments. In summary, the technical solution provided in the present application can achieve positioning assistance while realizing conductive capability, which is beneficial for improving positioning accuracy.

It is to be understood that both the foregoing general description and the following detailed description are exemplary and are intended to provide further explanation of the claimed technology.

### BRIEF DESCRIPTION OF DRAWINGS

The above and other objectives, features, and advantages of the present application will become more apparent by describing the embodiments of the present application in more detail with reference to the accompanying drawings. The drawings are used to provide a further understanding of the embodiments of the present application and constitute a part of the specification. Together with the embodiments of the present application, they serve to explain the present application and do not constitute a limitation on the present application. In the drawings, the same reference numerals generally represent the same parts or steps.

FIG. 1 is a schematic structural diagram of a conductive component according to an embodiment of the present application.

FIG. 2 is a top view of the conductive component shown in FIG. 1.

FIG. 3 is an overall schematic structural diagram of an image forming apparatus according to an embodiment of the present application.

FIG. 4 is a side view of an image forming apparatus according to an embodiment of the present application.

FIG. 5 is a schematic diagram of the relationship between conductive members and power supply members according to an embodiment of the present application.

FIG. 6 is a first schematic structural diagram of a process cartridge according to an embodiment of the present application.

FIG. 7 is a second schematic structural diagram of a process cartridge according to an embodiment of the present application.

FIG. 8 is a schematic structural diagram of another conductive component according to an embodiment of the present application.

FIG. 9 is a schematic structural diagram of a process cartridge according to an embodiment of the present application.

FIG. 10 is another schematic structural diagram of a process cartridge according to an embodiment of the present application.

### DETAILED DESCRIPTION OF THE INVENTION

To make the objectives, technical solutions, and advantages of the present application more apparent, the exemplary embodiments of the present application will be described in detail below with reference to the accompanying drawings. Obviously, the described embodiments are only a part of the embodiments of the present application, and not all of them. It should be understood that the present application is not limited by the exemplary embodiments described herein.

Embodiments of the Present Application Provide a Conductive component.

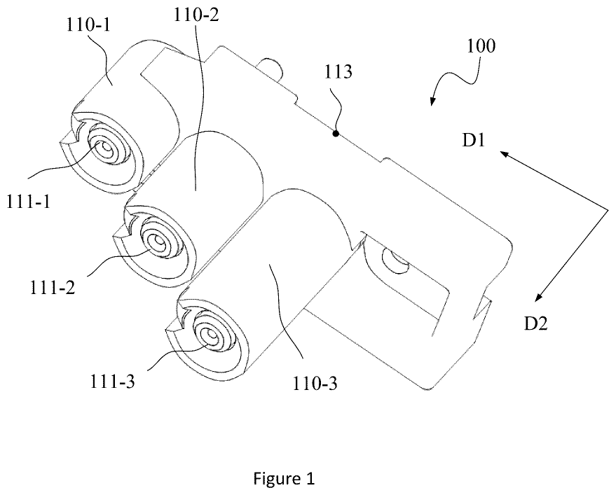

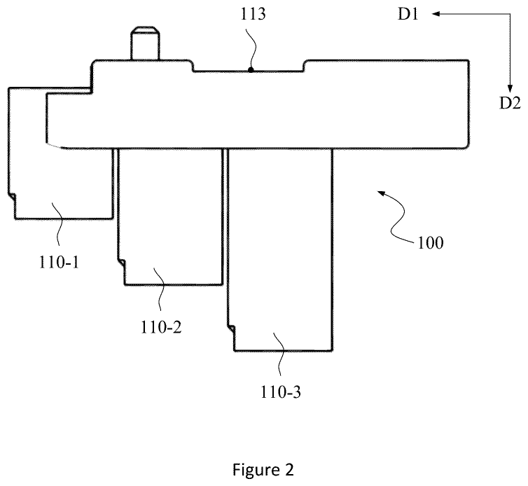

Please refer to FIGS. 1 and 2. FIG. 1 is a schematic structural diagram of a conductive component according to an embodiment of the present application, and FIG. 2 is a top view of the conductive component shown in FIG. 1. As shown in FIGS. 1 and 2, the conductive component 100 includes: a plurality of conductive members 110. The conductive members 110 include electrical contacts 111. In other words, the conductive members 110 can achieve electrical connection with other conductive objects through the electrical contacts 111. For example, the conductive members 110 can achieve electrical connection with a power supply device (e.g., a power supply member 210 in the image forming apparatus 200 or a power source) through the electrical contacts 111, and/or can also achieve electrical connection with a powered device (e.g., a load member in the process cartridge 300, or a load member in the conductive component 100) through the electrical contacts 111, which will not be elaborated. Specifically, the electrical contact 111 is the portion of the conductive member 110 that contacts and electrically connects with the power supply device.

It should be understood that FIG. 1 shows three conductive members 110, which can be respectively denoted as: a first conductive member 110-1, a second conductive member 110-2, and a third conductive member 110-3. Correspondingly, FIG. 1 also shows three electrical contacts 111, respectively: a first electrical contact 111-1, a second electrical contact 111-2, and a third electrical contact 111-3. It should be understood that FIG. 1 is merely exemplary, and in actual scenarios, there may be more or fewer conductive members 110, which is not particularly limited in the present application. Hereinafter, for ease of explanation, three conductive members 110 are still used as an example.

In the embodiments of the present application, at least two of the plurality of electrical contacts 111, there are different first projection lengths in a second direction (denoted as D2). The first projection length is a length between a first projection position A1 and a second projection position A2. The first projection position A1 is the projection position of the electrical contact 111 in the second direction. The second projection position A2 is the projection position of a first reference position 113 in the second direction.

It should be noted that the first projection position A1 refers to the projection position obtained by projecting the electrical contact 111 onto the second direction (a line) or a plane where the second direction lies. Further, it can be the projection position obtained by projecting the electrical contact 111 onto the plane defined by the second direction and the first direction, as shown in FIG. 1. In actual scenarios, the relevant projection positions can be obtained by projecting the electrical contact 111 along a direction perpendicular to the plane where the second direction lies (e.g., a third direction mentioned later, denoted as D3). Similarly, the second projection position A2 refers to the projection position obtained by projecting the first reference position 113 onto the second direction or the plane where the second direction lies. Further, it can be the projection position obtained by projecting the first reference position 113 onto the plane defined by the second direction and the first direction, as shown in FIG. 1. This will not be elaborated further.

In the embodiments of the present application, the second direction is parallel to the axial direction of the roller member. The second direction intersects the first direction (denoted as D1). Possibly, taking the D1 direction as a reference, the angle between the D2 direction and the D1 direction is between 45° and 135°, for example, the angle between D2 and D1 can be at least one of 45°, 60°, 75°, 90°, 105°, 120°, 135°. Of course, the angle between D2 and D1 can also be any other value within the range of 45° to 135°. In a preferred embodiment, the second direction and the first direction can be perpendicular to each other. In the embodiments of the present application, the first direction is related to the application scenario of the conductive component 100.

Exemplarily, the aforementioned conductive component 100 can be applied in a scenario where a process cartridge 300 and an image forming apparatus 200 are installed and matched. The image forming apparatus 200 can include, but is not limited to, a printing apparatus (or referred to as a printer), and the process cartridge 300 can be any cartridge detachably installed in the image forming apparatus 200. This cartridge can achieve electrical connection with the image forming apparatus 200 through the conductive component 100. For example, the process cartridge 300 involved in the embodiments of the present application can include, but is not limited to, a developing cartridge (or referred to as a developing unit), a drum cartridge, etc., which are not exhaustively listed. In this embodiment, the conductive component 100 can be used to achieve electrical connection between a load member 310 in the process cartridge 300 and a power supply member 210 in the image forming apparatus 200.

The load members 310 in the process cartridge 300 can be various, including but not limited to at least one of the following: a roller member 311, a toner doctor blade, a fixed resistor, a variable resistor. Specifically, at least one roller member 311 includes a developing roller. In addition, it can also include, but is not limited to, a feed roller, a photosensitive drum, etc., which are not exhaustively listed. In one possible embodiment, the roller member 311 includes a developing roller and/or a feed roller and/or a photosensitive drum.

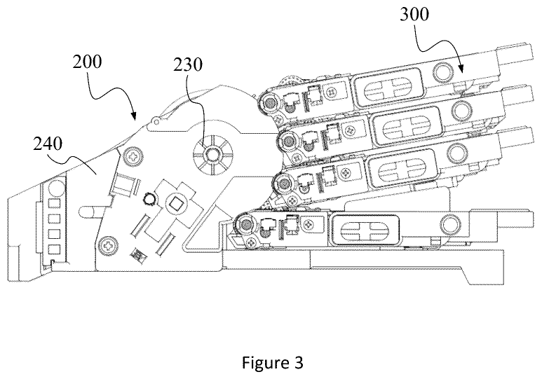

Specifically, as shown in FIG. 3, the image forming apparatus 200 has an installation cavity inside. An imaging component 230 and the process cartridge 300 (or referred to as a developing unit 300) need to be installed into the installation cavity respectively. The imaging component 230 needs to be installed into the installation cavity first, followed by the developing unit 300. The imaging component 230 is provided with a photosensitive drum (OPC), and the developing unit 300 is provided with a developing roller. When the imaging component 230 and the developing unit 300 are properly installed in the installation cavity, the developing roller and the photosensitive drum need to be arranged opposite each other, and they can contact or not contact each other. During printing or other image forming processes, toner on the developing roller can be adsorbed onto the surface of the photosensitive drum. Besides the developing roller, the developing unit 300 also has a feed roller and a toner doctor blade. The housing of the developing unit 300 also has an accommodating cavity for accommodating toner. The function of the feed roller is to convey the toner from the accommodating cavity to the developing roller. The developing roller is charged and can adsorb toner. The toner doctor blade is used to level the toner on the surface of the developing roller, so that the toner on the surface of the developing roller is evenly distributed, thereby ensuring that all areas on the surface of the photosensitive drum can uniformly adsorb toner. In one application scenario, the aforementioned load members 310 all need to be electrically powered to work. Therefore, electrical connection between these load members 310 and the power source or the power supply member 210 can be achieved through the electrical contacts in the conductive component 100.

In this scenario, the conductive component 100 provided by the embodiments of the present application can be disposed on the process cartridge 300 or the image forming apparatus 200. The process cartridge 300 is detachably installable into the body of the image forming apparatus 200. The conductive component 100 is used to achieve electrical connection between the power supply member 210 of the image forming apparatus 200 and at least one of the load members 310 of the process cartridge 300. The load member 310 includes a roller member 311. Thus, the electrical contacts 111 in the conductive members 110 can be used to contact the power supply member 210 to connect to the power source. Moreover, in the embodiments of the present application, at least two of the plurality of electrical contacts 111 have different first projection lengths in the second direction. In this embodiment, the second direction intersects the first direction, the second direction is parallel to the axial direction of the roller member, and the first direction is the installation direction of the process cartridge 300.

It should be noted that in the examples of the present application, the first reference position 113 is any point on the side of the conductive component 100 away from the electrical contacts 111. In specific implementation, the first reference position 113 can be a position on the conductive component 100, and this position is away from the electrical contacts 111 in the second direction. For example, if the conductive component 100 is a cubic structure and the electrical contacts 111 are located on the left side surface of the conductive component 100, then the second direction can be perpendicular to this left side surface, for example, parallel to the bottom surface or the front side surface of the conductive component 100. Then the first reference position 113 can be any position on the right side of this left side surface on the conductive component 100, for example, any point on the right side surface of the conductive component 100. In actual scenarios, the first reference position 113 can be custom selected or configured, and its projection position in the second direction (i.e., the second projection position) can be fixed.

It should be noted that the conductive component 100 can be an independent device separate from the process cartridge 300 and the image forming apparatus 200. Alternatively, the conductive component 100 can be disposed on the process cartridge 300, as part of the process cartridge 300, for achieving electrical connection between the load member 310 in the process cartridge 300 and the power supply member 210. Alternatively, the conductive component 100 can be disposed on the image forming apparatus 200, as part of the image forming apparatus 200, for achieving alignment during installation with the process cartridge 300.

When the process cartridge 300 is used for installation into the image forming apparatus 200 and specifically used for developing capability, one end of the roller member 311 can specifically be the conductive member 110, and the conductive member 110 has the electrical contact 111. Alternatively, one end of the roller member 311 can be electrically connected to the electrical contact 111 through a connecting member. Thus, when the process cartridge 300 is installed via the conductive component 100, the roller member 311 can achieve electrical connection with the power source through the electrical contact 111 and the power supply member 210, thereby powering on and starting. In actual scenarios, the roller member 311 (especially the developing roller) generally intersects the plane where the electrical contacts 111 are located and is fixedly disposed. Preferably, to facilitate electrical connection, the roller member 311 can be perpendicular to the plane where the electrical contacts 111 are located. In the embodiments of the present application, based on the fixedly disposed roller member 311, the second direction is determined based on the axial direction of the roller member 311. That is, the second direction is parallel to the axial direction of the roller member 311. Preferably, in one embodiment, the second direction is parallel to the axial direction of the developing roller.

Moreover, in the embodiments of the present application, the first direction is the installation direction of the process cartridge 300. To achieve installation matching between the process cartridge 300 and the image forming apparatus 200, the first direction is related to the structure of the image forming apparatus 200. For different image forming apparatuses 200, the first direction is correspondingly different to achieve installation adaptation between the two.

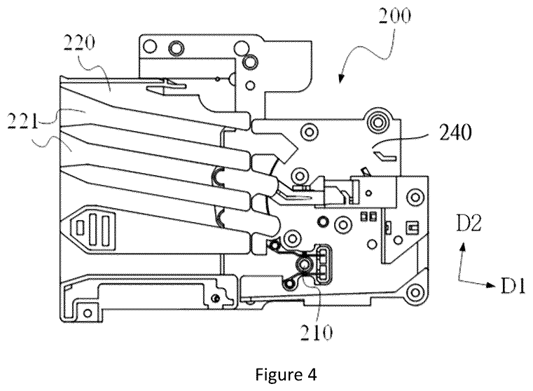

An example is illustrated with reference to FIGS. 3 and 4. As shown in FIG. 4, the body of the image forming apparatus 200 includes an inner side plate 220. The inner side plate 220 is provided with a guide groove 221 for guiding the installation direction of the process cartridge 300. Specifically, at least one of the conductive members 110 can generally protrude (i.e., protrude from the side surface of the conductive component 100 where it is located). During the installation of the process cartridge 300, the conductive members 110 can extend into the guide groove 221 and slide along the guide groove 221. Thus, the process cartridge 300 can be detachably installed into the image forming apparatus 200 in a plug-in/pull-out manner. The structure after installation can be referred to in FIG. 3.

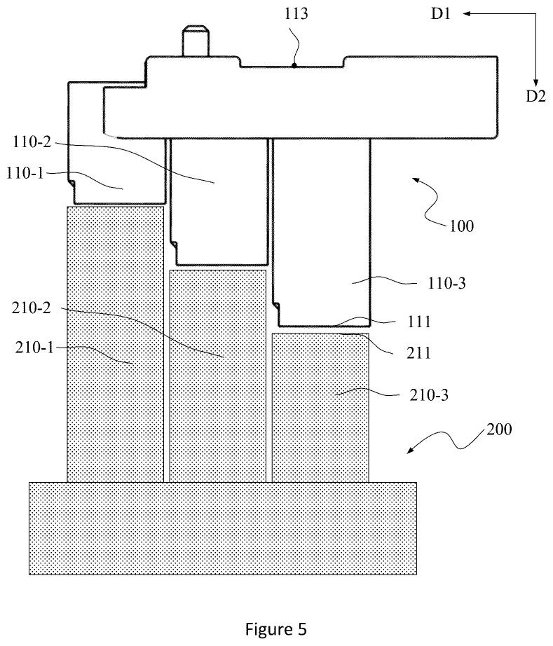

Furthermore, in the embodiments of the present application, as shown in FIG. 5, the image forming apparatus 200 is also provided with a plurality of power supply members 210 (that is, 210-1, 201-2, 210-3), at least two of contact portions 211 of the plurality of power supply members 210 have different first projection lengths formed in the second direction. Moreover, for a set of power supply members 210 and conductive members 110 that can adapt under normal installation conditions, if the contact portion 211 of a power supply member 210 has a longer first projection length formed in the second direction, the corresponding electrical contact 111 of the conductive member 110 has a shorter first projection length formed in the second direction.

Exemplarily, FIG. 5 shows one possible embodiment. In this embodiment, at least two of the contact portions 211 of the plurality of power supply members 210 have different first projection lengths formed in the second direction, and they sequentially increase along the first direction. Meanwhile, at least two of the electrical contacts 111 of the conductive members 110 in the conductive component 100 have different first projection lengths in the second direction, and they sequentially decrease according to the arrangement order along the first direction. Thus, when the conductive component 100 or the process cartridge 300 provided with the conductive component 100 is correctly installed with the image forming apparatus 200, the electrical connection relationship as shown in FIG. 4 can be formed.

In other words, the positions of the electrical contacts 111 can match the power supply members 210. Thus, after the two are installed and matched, the electrical contacts 111 can contact and electrically connect with the power supply members 210. In this embodiment, the first direction can also be specifically understood as the plug-in/pull-out direction of the process cartridge 300, and can also be understood as the extension direction of the guide groove 221 in the image forming apparatus 200. The guide groove 221 is disposed on the inner side plate 220 for guiding the installation direction of the process cartridge 300. In other words, the installation direction of the process cartridge 300 is parallel to the extension direction of the guide groove 221.

Therefore, by designing at least two of the plurality of electrical contacts 111 to have different first projection lengths in the second direction, at least two conductive members 110 can have different lengths in the axial direction of the roller member. Thus, by matching the lengths of the conductive members 110 with the image forming apparatus 200, precise positioning and matching between the conductive members 110 and the power supply members 210 can be achieved. Consequently, while satisfying the requirement for the electrical contacts 111 to contact the contact portions 211 of the power supply members for conduction, the length of the conductive members 110 themselves in the second direction, which needs to be provided anyway, is utilized to assist in achieving positioning matching. This not only provides good conductive performance and stability but also allows omission of positioning members or eliminates special precision requirements and costs for positioning members in some embodiments. In summary, the technical solution provided in the present application can achieve positioning assistance while realizing conductive capability, which is beneficial for improving positioning accuracy.

To further illustrate possible forms of the first direction, the following takes the conductive component 100 disposed on the process cartridge 300 as an example and illustrates it in combination with the specific structure of the process cartridge 300.

In one exemplary embodiment, the first direction is parallel to the connecting line direction between a third projection position and a fourth projection position. The process cartridge 300 includes a positioning member 320. The third projection position is the projection position of the axis center of the roller member 311 projected along the second direction, and the fourth projection position is the projection position of the positioning member 320 projected along the second direction. In this embodiment, the third projection position and the fourth projection position are positions determined by projecting the relevant components along the second direction onto a plane perpendicular to the second direction. In actual scenarios, the conductive component 100 is generally also provided with a positioning member 320. The positioning member 320 generally has a protruding or recessed form, used for positioning its installation position during the installation process of the process cartridge 300. For example, the positioning member 320 can specifically be a positioning protrusion. When the process cartridge 300 is inserted into the image forming apparatus 200 along the installation direction, the positioning protrusion can partially engage with a positioning recess in the image forming apparatus 200, such as the aforementioned guide groove 221, to achieve the installation positioning function. In actual scenarios, the positioning member 320 can be disposed on the same side as the electrical contacts 111 or on the opposite side of the process cartridge 300.

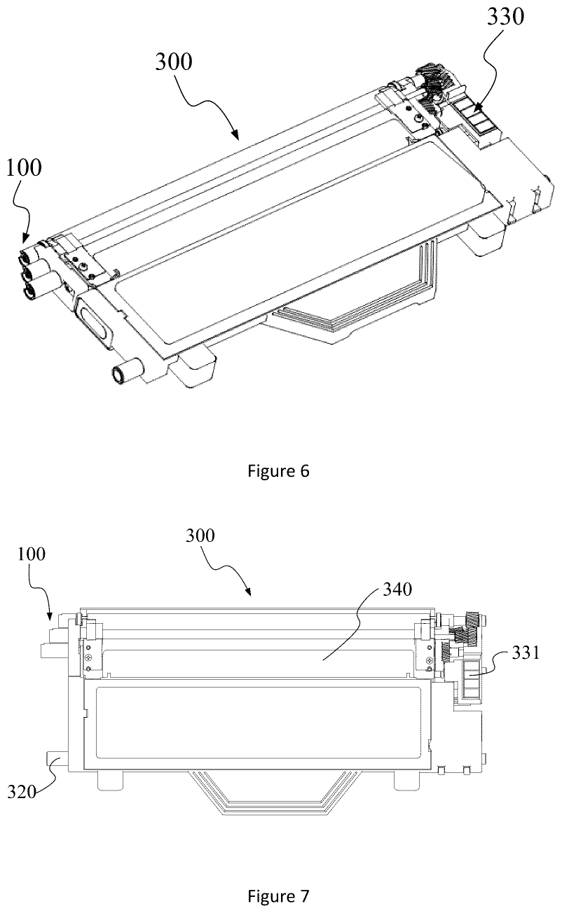

Or, in another exemplary embodiment, the process cartridge 300 includes an information processing apparatus 330. The information processing apparatus 330 includes a plurality of functional electrical contacts 331. The first direction is parallel to the sequential arrangement direction of the plurality of functional electrical contacts 331. The information processing apparatus 330 can specifically be any device or component in the process cartridge 300 that has information processing capability. For example, the information processing apparatus 330 can include, but is not limited to, a chip. The information processing apparatus 330 can achieve the transmission of information, instructions, etc., with other devices through the functional electrical contacts 331. Specifically, please refer to FIG. 6. The information processing apparatus 330 may have four functional electrical contacts 331, which are a power contact (VCC), a data signal contact (SDA), a clock signal contact (CLK), and a ground contact (GND). The four functional electrical contacts 331 are used to contact four electrical contact portions on the image forming apparatus, such as conductive spring pieces, contact pins, electrical contacts, etc. The aforementioned four functional electrical contacts 331 are sequentially spaced apart along the same direction, and the first direction is parallel to the direction in which the aforementioned four functional electrical contacts 331 are sequentially arranged.

It can be understood that the information processing apparatus has a plurality of conductive terminals. The conductive terminals can be of different shapes such as square, circular, etc. As shown in FIG. 6, the functional electrical contacts 331 are the portions of the conductive terminals used for contacting the electrical contact portions of the image forming apparatus.

There may be other types of terminals on the information processing apparatus 330 that do not directly contact the electrical contact portions of the image forming apparatus. Such terminals may also be arranged along the same direction as the aforementioned conductive terminals; or may not be arranged along the same direction as the aforementioned conductive terminals.

Of course, depending on the situation, the number of functional electrical contacts 331 on the information processing apparatus 330 can also be other, such as more than four or less than four.

Furthermore, the process cartridge 300 generally has a plurality of outer wall surfaces. The information processing apparatus 330 can be disposed at the connection between different outer wall surfaces of the process cartridge 300 or on any outer wall surface.

Or, in another exemplary embodiment, the process cartridge 300 includes an information processing apparatus 330. The information processing apparatus 330 includes a plurality of functional electrical contacts 331. The first direction is parallel to the connecting line direction between a first projection position and a third projection position. The first projection position is the projection position of the axis center of the roller member 311 projected along the second direction, and the third projection position is the projection position of the functional electrical contact 331 projected along the second direction. The process cartridge 300 has a first end surface and a second end surface respectively located at both ends of the roller member. At least one functional electrical contact 331 is located on the first end surface or the second end surface. The functional electrical contact 331 located on the first end surface or the second end surface forms the third projection position when projected along the third direction.

Specifically, the information processing apparatus 330 may have four functional electrical contacts 331, which are a power contact (VCC), a data signal contact (SDA), a clock signal contact (CLK), and a ground contact (GND). The four functional electrical contacts 331 are used to contact four electrical contact portions on the image forming apparatus, such as conductive spring pieces, contact pins, electrical contacts, etc. Among them, at least one of the four functional electrical contacts 331 is located on the first end surface or the second end surface.

Similarly, there may be other types of terminals on the information processing apparatus 330 that do not directly contact the electrical contact portions of the image forming apparatus. Such terminals cannot be used for projection to form the third projection position.

It should be noted that when it is necessary to determine a direction or length based on different projection positions projected along the same projection direction, the aforementioned projection positions should be located within the same projection plane perpendicular to the aforementioned projection direction. Similarly, when it is necessary to judge whether projections of different projections along the same projection direction overlap or have a specific positional relationship, the aforementioned projections should also be located within the same projection plane perpendicular to the aforementioned projection direction.

In the embodiments of the present application, regarding the first projection lengths of at least two of the plurality of electrical contacts 111 in the second direction, in specific implementation, the conductive component 100 can have a plurality of electrical contacts 111. The first projection lengths of the plurality of electrical contacts 111 in the second direction can all be different, or some can be the same. For example, as shown in FIGS. 1, 2, and 4, the first projection lengths of the plurality of electrical contacts 111 in the second direction are all different. For another example, in some possible embodiments, one of the plurality of electrical contacts 111 has the longest first projection length in the second direction, and the remaining one or more electrical contacts 111 have the same first projection length in the second direction.

In actual implementation scenarios, the first projection lengths of the plurality of electrical contacts 111 can be set to increase or decrease sequentially according to a certain order, such as the first direction and/or the third direction.

In one exemplary embodiment, at least two of the plurality of electrical contacts 111 are spaced apart along the first direction. The first projection lengths in the second direction of at least two of the plurality of electrical contacts 111 sequentially decrease according to the arrangement order of the corresponding electrical contacts 111 along the first direction. FIG. 4 shows this situation. In this embodiment, since the first projection lengths of the various electrical contacts 111 in the second direction are different, during the installation process of the conductive component 100 or the process cartridge 300 provided with the conductive component 100, in addition to achieving the effects of contact conduction or auxiliary positioning, it can further avoid scratching between the electrical contacts 111 and the contact portions 211 of the power supply members 210, preventing unnecessary scratching contact during a single installation process and reducing potential power supply instability caused by frequent scratching, which is beneficial for further improving power supply stability.

Furthermore, the first projection length corresponding to each electrical contact 111 can be greater than, equal to, or less than a second projection length, where the second projection length is the distance between the second projection position and the plane where the electrical contact is located (e.g., the aforementioned left side surface). Generally, the first projection length in the second direction of at least one of the plurality of electrical contacts is greater than the second projection length. In other words, generally, at least one of the plurality of electrical contacts can protrude from its located plane. Still taking the situation shown in FIGS. 1 and 5 as an example, the electrical contacts 111 of the three conductive members 110 in FIG. 5 can all protrude from the plane of the conductive component 100 where the conductive members 110 are located. Alternatively, among the three conductive members 110 in FIGS. 1 and 5, only one electrical contact 111 may protrude, and the other electrical contacts 111 may be flush with the plane of the conductive component 100 where the conductive members 110 are located or even recessed, which will not be elaborated.

Moreover, the embodiments of the present application do not particularly restrict the arrangement relationship of the plurality of electrical contacts 111 in the first direction and the third direction. In actual implementation scenarios, the plurality of electrical contacts 111 can be spaced apart in the first direction and/or the third direction.

In one exemplary embodiment, as shown in FIGS. 1 and 5, the plurality of electrical contacts 111 can be spaced apart along the first direction. In this embodiment, the plurality of electrical contacts 111 can be aligned in the second direction, or they can be spaced apart. When spaced apart, in specific implementation, they can be set by spacing a certain physical space, or, in a preferred solution, insulating materials can be provided to prevent short circuits or breakdown issues.

Furthermore, in the embodiments of the present application, the projection positions of the plurality of electrical contacts 111 of the conductive component 100 in the second direction can be relatively close.

In one exemplary embodiment, the projection positions of at least two of the plurality of electrical contacts 111 along the first direction at least partially overlap.

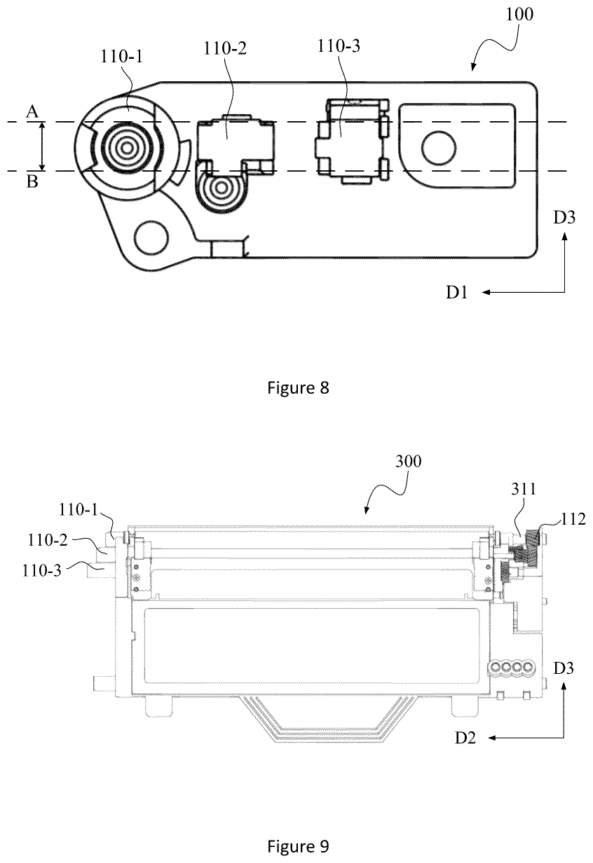

Or, in another possible embodiment, the projection positions of at least two of the plurality of electrical contacts 111 along the first direction at least partially overlap with a first region. The first region is the projection region of the outer contour of the roller shaft of the roller member 311 in the first direction. In specific implementation, when the process cartridge 300 is specifically a developing unit, the developing roller, as the most important developing device in the developing unit, has a relatively fixed position in the developing unit. The spatial positions of the various electrical contacts 111 can be designed accordingly. In other words, in this embodiment, the roller member 311 can specifically be the developing roller. At this time, reference can be made to FIG. 8. As shown in FIG. 8, viewed from the axial direction of the developing roller (the third direction, also the side view of the conductive component 100), the developing roller can consist of an inner roller shaft and an outer protective structure. The projection of the outer contour of the roller shaft of the developing roller in the first direction is the interval [A, B] between point A and point B in the first direction. In this embodiment, the projection positions of at least two of the plurality of electrical contacts 111 along the first direction at least partially overlap with the interval [A, B]. Thus, the plurality of electrical contacts 111 can be not far apart in the second direction and spaced apart in the first direction. As shown in FIG. 8, the plurality of electrical contacts 111 overall present an effect of being arranged horizontally in the first direction.

Furthermore, in a process cartridge 300 provided by an embodiment of the present application, the process cartridge 300 includes a plurality of electrical contacts 111. The plurality of electrical contacts 111 include a first electrical contact 111-1, a second electrical contact 111-2, and a third electrical contact 111-3. The load members 310 include a first load member, a second load member, and a third load member. The first electrical contact 111-1 is electrically connected to the first load member, the second electrical contact 111-2 is electrically connected to the second load member, and the third electrical contact 111-3 is electrically connected to the third load member. At least two of the first load member, the second load member, and the third load member are different. The third electrical contact 111-3, the second electrical contact 111-2, and the first electrical contact 111-1 are located on the same side of the conductive component and are arranged sequentially along the first direction. As mentioned before, at least two types of load members can differ in type, model, or value, or a combination thereof.

The load members 310 involved in the embodiments of the present application can include, but are not limited to, at least one of the following: a roller member 311, a toner doctor blade, a fixed resistor, a variable resistor.

The roller member 311 involved in the embodiments of the present application can include, but is not limited to: a developing roller and/or a feed roller and/or a photosensitive drum.

In a process cartridge 300 provided by an embodiment of the present application, the connection relationship between the electrical contacts 111 and the load members 310 is not particularly limited. In actual scenarios, one electrical contact 111 can be used for electrical connection with one load member 310, or can be used for electrical connection with a plurality of load members 310. The electrical connection method between the electrical contact 111 and the load member 310 can be direct contact connection between the two, or indirect electrical connection through a bridging device (e.g., a moving mechanism involved later). Exemplarily, the embodiments of the present application provide the following several possible implementation methods.

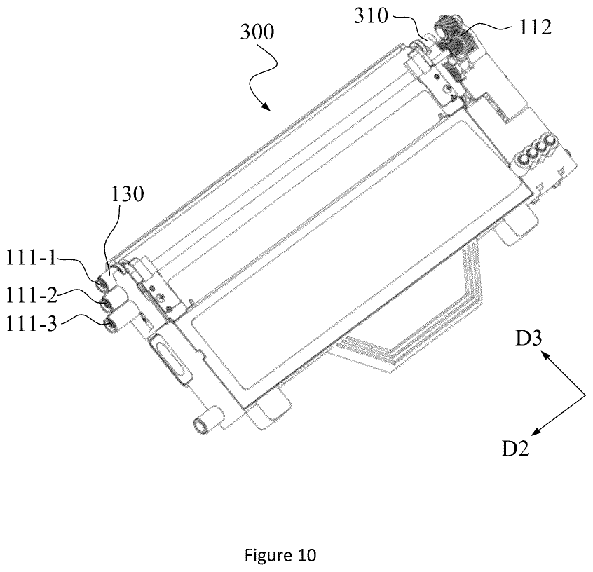

In one exemplary embodiment, the first load member includes a developing roller, the second load member includes a feed roller, the third load member includes a toner doctor blade, the first electrical contact 111-1 is electrically connected to the developing roller, the second electrical contact 111-2 is electrically connected to the feed roller, and the third electrical contact 111-3 is electrically connected to the toner doctor blade. As shown in FIG. 10, the first electrical contact 111-1 can be located at the end surface of a protrusion portion 130, pass through the inside of the protrusion portion 130, and be electrically connected to the developing roller. The feed roller and the toner doctor blade are electrically connected to the second electrical contact 111-2 and the third electrical contact 111-3 respectively. The second electrical contact 111-2 and the third electrical contact 111-3 can be located on both sides of the protrusion portion respectively.

Or, in another exemplary embodiment, the first load member further includes a feed roller. The feed roller and the developing roller are connected in parallel and then electrically connected to the first electrical contact 111-1. In this embodiment, the first electrical contact 111-1 is electrically connected to a plurality of first load members (i.e., the feed roller and the developing roller). In actual scenarios, this can be achieved through the aforementioned voltage division circuit, and the branches of the voltage division circuit can also be additionally designed with one or more of a voltage adjustment module, a current adjustment module, a power adjustment module, etc.

Or, in another exemplary embodiment, the first load member further includes a feed roller and a toner doctor blade. The feed roller, the toner doctor blade, and the developing roller are connected in parallel and then electrically connected to the first electrical contact 111-1. In this embodiment, the first electrical contact 111-1 is electrically connected to three load members (i.e., the feed roller, the toner doctor blade, and the developing roller). This can be achieved through a voltage division circuit, and the branches of the voltage division circuit can also be additionally designed with one or more of a voltage adjustment module, a current adjustment module, a power adjustment module, etc.

Reference is made to the foregoing and will not be repeated.

Furthermore, in the embodiments of the present application, the plurality of electrical contacts 111 in the process cartridge 300 can be set in a fixed form, or at least one of the plurality of electrical contacts 111 can be movably disposed.

For example, movable disposition can be achieved through a moving mechanism. In one exemplary embodiment, the conductive component 100 further includes a moving mechanism. The moving mechanism is used to move at least two of the plurality of conductive members 110 from a first position to a second position. The electrical contacts 111 of the at least two conductive members 110 located at the second position have different first projection lengths in the second direction.

Further, in this embodiment, the conductive members 110 include a first conductive member 110-1, a second conductive member 110-2, and a third conductive member 110-3. The plurality of electrical contacts 111 include a first electrical contact 111-1, a second electrical contact 111-2, and a third electrical contact 111-3. The first electrical contact 111-1 is located on the first conductive member 110-1, the second electrical contact 111-2 is located on the second conductive member 110-2, and the third electrical contact 111-3 is located on the third conductive member 110-3. The first electrical contact 111-1 and/or the second electrical contact 111-2 and/or the third electrical contact 111-3 is movably disposed on the body of the conductive component or the cartridge body 340 of the process cartridge 300.

The moving mechanism is an elastic member. The first conductive member 110-1 and/or the second conductive member 110-2 and/or the third conductive member 110-3 is disposed on the body of the conductive component or the cartridge body 340 of the process cartridge 300 via the elastic member. The first conductive member 110-1 and/or the second conductive member 110-2 and/or the third conductive member 110-3 moves at least two of the plurality of conductive members 110 from the first position to the second position through elastic deformation of the elastic member, so that the first electrical contact 111-1, the second electrical contact 111-2, and the third electrical contact 111-3 have different first projection lengths in the second direction.

Additionally, exemplarily, the movable disposition can also be achieved through an elastic conductive portion 112. In one exemplary embodiment, in the process cartridge 300, at least two of the plurality of conductive members 110 include an elastic conductive portion 112. The elastic conductive portion 112 is used to contact the power supply member 210 to connect to the power source. When the elastic conductive portion 112 contacts the power supply member 210, it is in an elastically deformed state. The contact portion between the elastic conductive portion 112 and the power supply member 210 is the electrical contact 111. The electrical contacts 111 of the elastic conductive portions 112 of at least two conductive members 110 have different first projection lengths in the second direction.

In one implementation of this situation, the conductive members 110 include a first conductive member 110-1, a second conductive member 110-2, and a third conductive member 110-3. The plurality of electrical contacts 111 include a first electrical contact 111-1, a second electrical contact 111-2, and a third electrical contact 111-3. The first electrical contact 111-1 is located on the first conductive member 110-1, the second electrical contact 111-2 is located on the second conductive member 110-2, and the third electrical contact 111-3 is located on the third conductive member 110-3. The first electrical contact 111-1 and/or the second electrical contact 111-2 and/or the third electrical contact 111-3 is movably disposed on the body of the conductive component or the cartridge body 340 of the process cartridge 300.

The first conductive member 110-1 and/or the second conductive member 110-2 and/or the third conductive member 110-3, through elastic deformation, cause the first electrical contact 111-1, the second electrical contact 111-2, and the third electrical contact 111-3 to have different first projection lengths in the second direction.

Furthermore, in a preferred embodiment of the present application, the second direction is perpendicular to the third direction and the first direction.

Parts not described in detail can be referred to the foregoing and will not be repeated.

The embodiments of the present application also provide a process cartridge 300. Please refer to FIG. 9 or FIG. 10. The process cartridge 300 includes: a cartridge body 340; a load member 310, at least one of the load members 310 including a roller member 311 which is rotatably disposed on the cartridge body 341; and a conductive component 100, the conductive component 100 including a plurality of conductive members 110 which are configured to achieve electrical connection between a power supply member 210 of the image forming apparatus 200 and the load member 310; the conductive members 110 including electrical contacts 111 which are configured to contact the power supply member 210 to connect to a power source; wherein at least two of the plurality of electrical contacts 111 have different first projection lengths in a second direction; the first projection length being a length between a first projection position and a second projection position; the first projection position being a projection position of the electrical contact 111 in the second direction; the second projection position being a projection position of a first reference position 113 in the second direction; the first reference position 113 being any point on a side of the conductive component 100 away from the electrical contacts 111; wherein the second direction intersects the first direction, and the second direction is parallel to an axial direction of the roller member 311.

In this embodiment, possible implementation methods of the conductive component 100 can be referred to the foregoing. The following briefly explains. In the embodiments of the present application, the process cartridge 300 can be provided with the conductive component 100. The setting method can be various: the conductive component 100 can be detachably disposed on the cartridge body 340; or, the conductive component 100 can be fixedly disposed on the cartridge body 340; or, the conductive component 100 can be provided independently of the cartridge body 340. The present application does not impose mandatory binding restrictions between the process cartridge 300 and the conductive members 110; they can exist independently or be used in cooperation.

Regarding the directions in the process cartridge 300, the first direction is parallel to the installation direction of the process cartridge 300 and also parallel to the extension direction of the guide groove 221 in the image forming apparatus 200. At the specific implementation level, the embodiments of the present application also specifically provide the following several possible embodiments.

In one exemplary embodiment, the first direction is parallel to the connecting line direction between a third projection position and a fourth projection position. The process cartridge 300 includes a positioning member 320. The third projection position is the projection position of the axis center of the roller member 311 projected along the second direction, and the fourth projection position is the projection position of the positioning member 320 projected along the second direction.

Or, in another exemplary embodiment, the process cartridge 300 includes an information processing apparatus 330. The information processing apparatus 330 includes a plurality of functional electrical contacts 331. The first direction is parallel to the sequential arrangement direction of the plurality of functional electrical contacts 331. The information processing apparatus 330 can specifically be any device or component in the process cartridge 300 that has information processing capability. For example, the information processing apparatus 330 can include, but is not limited to, a chip. The information processing apparatus 330 can achieve the transmission of information, instructions, etc., with other devices through the functional electrical contacts 331.

Or, in another exemplary embodiment, the process cartridge 300 includes an information processing apparatus 330. The information processing apparatus 330 includes a plurality of functional electrical contacts 331. The first direction is parallel to the connecting line direction between a third projection position and a fourth projection position. The third projection position is the projection position of the axis center of the roller member 311 projected along the second direction, and the fourth projection position is the projection position of the functional electrical contact 331 projected along the second direction.

In a process cartridge 300 provided by an embodiment of the present application, the projection positions of at least two of the plurality of electrical contacts 111 along the first direction at least partially overlap; or, the projection positions of at least two of the plurality of electrical contacts 111 along the first direction at least partially overlap with a first region. The first region is the projection region of the outer contour of the roller shaft of the roller member 311 in the first direction. Regarding the first region, reference can be made to the relevant description above, which will not be repeated.

In a process cartridge 300 provided by an embodiment of the present application, the first projection lengths of the plurality of electrical contacts 111 in the second direction are all different.

In a process cartridge 300 provided by an embodiment of the present application, at least two of the plurality of electrical contacts 111 are spaced apart along the first direction. The first projection lengths in the second direction of at least two of the plurality of electrical contacts 111 sequentially decrease according to the arrangement order of the corresponding electrical contacts 111 along the first direction.

In a process cartridge 300 provided by an embodiment of the present application, the plurality of electrical contacts 111 include a first electrical contact 111-1, a second electrical contact 111-2, and a third electrical contact 111-3. The load members 310 include a first load member, a second load member, and a third load member. The first electrical contact 111-1 is electrically connected to the first load member, the second electrical contact 111-2 is electrically connected to the second load member, and the third electrical contact 111-3 is electrically connected to the third load member. At least two of the first load member, the second load member, and the third load member are different. The third electrical contact 111-3, the second electrical contact 111-2, and the first electrical contact 111-1 are located on the same side of the conductive component 100 and are arranged sequentially along the first direction. As mentioned before, at least two types of load members can differ in type, model, or value, or a combination thereof.

The load members 310 involved in the embodiments of the present application can include, but are not limited to, at least one of the following: a roller member 311, a toner doctor blade, a fixed resistor, a variable resistor.

The roller member 311 involved in the embodiments of the present application can include, but is not limited to: a developing roller and/or a feed roller and/or a photosensitive drum.

In a process cartridge 300 provided by an embodiment of the present application, the connection relationship between the electrical contacts 111 and the load members 310 is not particularly limited. In actual scenarios, one electrical contact 111 can be used for electrical connection with one load member 310, or can be used for electrical connection with a plurality of load members 310. The electrical connection method between the electrical contact 111 and the load member 310 can be direct contact connection between the two, or indirect electrical connection through a bridging device (e.g., a moving mechanism involved later). For example, the embodiments of the present application provide the following several possible implementation methods.

In one exemplary embodiment, the first load member includes a developing roller, the second load member includes a feed roller, the third load member includes a toner doctor blade, the first electrical contact 111-1 is electrically connected to the developing roller, the second electrical contact 111-2 is electrically connected to the feed roller, and the third electrical contact 111-3 is electrically connected to the toner doctor blade.

Or, in another exemplary embodiment, the first load member further includes a feed roller. The feed roller and the developing roller are connected in parallel and then electrically connected to the first electrical contact 111-1. In this embodiment, the first electrical contact 111-1 is electrically connected to a plurality of load members (i.e., the feed roller and the developing roller). In actual scenarios, this can be achieved through the aforementioned voltage division circuit, and the branches of the voltage division circuit can also be additionally designed with one or more of a voltage adjustment module, a current adjustment module, a power adjustment module, etc.

Or, in another exemplary embodiment, the first load member further includes a feed roller and a toner doctor blade. The feed roller, the toner doctor blade, and the developing roller are connected in parallel and then electrically connected to the first electrical contact 111-1. In this embodiment, the first electrical contact 111-1 is electrically connected to three load members (i.e., the feed roller, the toner doctor blade, and the developing roller). This can be achieved through a voltage division circuit, and the branches of the voltage division circuit can also be additionally designed with one or more of a voltage adjustment module, a current adjustment module, a power adjustment module, etc.

Reference is made to the foregoing and will not be repeated.

Furthermore, in the embodiments of the present application, the plurality of electrical contacts 111 in the process cartridge 300 can be spaced apart in a fixed form, or at least one of the plurality of electrical contacts 111 can be movably disposed.

Exemplarily, the movable disposition can be achieved through a moving mechanism. In one exemplary embodiment, the conductive component 100 further includes a moving mechanism. The moving mechanism is used to move at least two of the plurality of conductive members 110 from a first position to a second position. The electrical contacts 111 of the at least two conductive members 110 located at the second position have different first projection lengths in the second direction.

In one exemplary embodiment, the conductive members 110 include a first conductive member 110-1, a second conductive member 110-2, and a third conductive member 110-3. The plurality of electrical contacts 111 include a first electrical contact 111-1, a second electrical contact 111-2, and a third electrical contact 111-3. The first electrical contact 111-1 is located on the first conductive member 110-1, the second electrical contact 111-2 is located on the second conductive member 110-2, and the third electrical contact 111-3 is located on the third conductive member 110-3. The first electrical contact 111-1 and/or the second electrical contact 111-2 and/or the third electrical contact 111-3 is movably disposed on the body of the conductive component 100 or the cartridge body 340 of the process cartridge 300.

The moving mechanism is an elastic member. The first conductive member 110-1 and/or the second conductive member 110-2 and/or the third conductive member 110-3 is disposed on the body of the conductive component or the cartridge body 340 of the process cartridge 300 via the elastic member. The first conductive member 110-1 and/or the second conductive member 110-2 and/or the third conductive member 110-3 moves at least two of the plurality of conductive members 110 from the first position to the second position through elastic deformation of the elastic member, so that the first electrical contact 111-1, the second electrical contact 111-2, and the third electrical contact 111-3 have different first projection lengths in the second direction.

Additionally, exemplarily, the movable disposition can also be achieved through an elastic conductive portion 112. In one exemplary embodiment, in the process cartridge 300, at least two of the plurality of conductive members 110 include an elastic conductive portion 112. The elastic conductive portion 112 is used to contact the power supply member 210 to connect to the power source. When the elastic conductive portion 112 contacts the power supply member 210, it is in an elastically deformed state. The contact portion between the elastic conductive portion 112 and the power supply member 210 is the electrical contact 111. The electrical contacts 111 of the elastic conductive portions 112 of at least two conductive members 110 have different first projection lengths in the second direction.

In one implementation of this situation, the conductive members 110 include a first conductive member 110-1, a second conductive member 110-2, and a third conductive member 110-3. The plurality of electrical contacts 111 include a first electrical contact 111-1, a second electrical contact 111-2, and a third electrical contact 111-3. The first electrical contact 111-1 is located on the first conductive member 110-1, the second electrical contact 111-2 is located on the second conductive member 110-2, and the third electrical contact 111-3 is located on the third conductive member 110-3. The first electrical contact 111-1 and/or the second electrical contact 111-2 and/or the third electrical contact 111-3 is movably disposed on the body of the conductive component or the cartridge body 340 of the process cartridge 300.

The first conductive member 110-1 and/or the second conductive member 110-2 and/or the third conductive member 110-3, through elastic deformation, cause the first electrical contact 111-1, the second electrical contact 111-2, and the third electrical contact 111-3 to have different first projection lengths in the second direction.

Furthermore, in a preferred embodiment of the present application, the second direction is perpendicular to the first direction.

Moreover, in one embodiment of the present application, the plurality of electrical contacts 111 in the process cartridge 300 are spaced apart by an insulating material. For example, a certain distance can be spaced between the electrical contacts 111 or between the protrusion portions 130 where the electrical contacts 111 are located, and/or insulating materials can be provided to avoid short circuits or breakdown issues.

It can be understood that depending on the type of image forming apparatus 200, process cartridges 300 also have different specifications.

When the image forming apparatus 200 only has monochrome printing function, usually only one process cartridge 300 needs to be installed in one image forming apparatus 200.

When the image forming apparatus 200 has color printing function, there can be a plurality of process cartridges 300, and different process cartridges 300 are used for printing different colors. For example, four process cartridges 300 are used for cyan (C), magenta (M), yellow (Y), and black (K) printing respectively. The four process cartridges 300 can perform pure color printing separately in one printing job, or can print various different colors by superimposing and mixing the above four colors. In this case, at least one process cartridge 300 can be provided with the aforementioned conductive component 100. Of course, the process cartridge 300 may also be used for printing other colors, not limited to the above colors.

Parts not described in detail can be referred to the foregoing and will not be repeated.

The embodiments of the present application also provide an image forming apparatus 200. As shown in FIGS. 3 and 4, the image forming apparatus 200 includes: a body 240, the body 240 including an inner side plate 220 which is provided with a guide groove 221; a plurality of power supply members 210; wherein at least two of the contact portions 211 of the plurality of power supply members 210 have different first projection lengths formed in the second direction; the first direction is parallel to an extension direction of the guide groove 221, and the second direction intersects a plane in which the inner side plate 220 lies; wherein the guide groove 221 is configured to guide an installation direction of a conductive component 100 or a process cartridge 300.

Further, in one embodiment, at least two of the contact portions 211 of the plurality of power supply members 210 have different first projection lengths formed in the second direction, and sequentially increase along the first direction. Reference is made to the foregoing, which will not be elaborated.

In the embodiments of the present application, the first direction is parallel to the extension direction of the guide groove 221 and also parallel to the installation direction of the process cartridge 300. Its possible implementation methods can be referred to the foregoing, which will not be elaborated. The second direction and the first direction are respectively parallel to the plane where the inner side plate 220 lies. In other words, the plane formed by the second direction and the first direction is parallel to the plane where the inner side plate 220 lies.

In the embodiments of the present application, the process cartridge 300 and the conductive component 100 are used for adaptive installation with the image forming apparatus 200. Based on this, similar to the plurality of electrical contacts 111 mentioned before, at least two of the contact portions 211 of the plurality of power supply members 210 have different first projection lengths formed in the second direction. The spacing method can be spacing a certain physical distance or spacing by insulating materials.

Furthermore, in another possible embodiment of the present application, the projection positions of at least two of the plurality of power supply members 210 along the first direction in the image forming apparatus 200 at least partially overlap; or, the projection positions of at least two of the plurality of power supply members 210 along the first direction at least partially overlap with a first region.

Furthermore, in another possible embodiment of the present application, the plurality of power supply members 210 in the image forming apparatus 200 are spaced apart in the third direction and/or the first direction. The third direction intersects the first direction and the second direction. Preferably, the third direction can be perpendicular to the first direction and the second direction respectively. Moreover, in the installation scenario of the process cartridge 300, the third direction can also be parallel to the axial direction of the roller member 311. This will not be elaborated.

Further, in specific implementation of the embodiments of the present application, the plurality of power supply members 210 can include: a first power supply member, a second power supply member, and a third power supply member. In one implementation, the first power supply member can be recessed in the second direction relative to the second power supply member and the third power supply member. To adapt to the power supply structure design of the image forming apparatus 200, the first electrical contact 111-1 in the conductive component 100 can also protrude in the second direction relative to the second electrical contact 111-2 and the third electrical contact 111-3. Or, in another implementation, the distances by which the second power supply member and the first power supply member or the third power supply member are recessed along the second direction sequentially increase or decrease. Correspondingly, to adapt to this design, the distances by which the second electrical contact 111-2 and the first electrical contact 111-1 or the third electrical contact 111-3 in the conductive component 100 protrude along the second direction sequentially increase or decrease.

For the image forming apparatus 200, the positions of the plurality of power supply members 210 in the image forming apparatus 200 are generally fixedly designed. Based on the above design, when the conductive component 100 or the process cartridge 300 provided with the conductive component 100 is installed into this image forming apparatus 200, by designing at least two of the plurality of electrical contacts to have different first projection lengths in the second direction, at least two conductive members can have different lengths in the axial direction of the roller member. Thus, by matching the lengths of the conductive members with the image forming apparatus, precise positioning and matching between the conductive members and the power supply members can be achieved. Therefore, while satisfying the requirement for the electrical contacts to contact the power supply members for conduction, the length of the conductive members themselves in the second direction, which needs to be provided anyway, is utilized to assist in achieving positioning matching. This not only provides good conductive performance and stability but also allows omission of positioning members or eliminates special precision requirements and costs for positioning members in some embodiments. In summary, the technical solution provided in the present application can achieve positioning assistance while realizing conductive capability, which is beneficial for improving positioning accuracy.

Parts not described in detail can be referred to the foregoing and will not be repeated.

The basic principles of the present application have been described above in connection with specific embodiments. However, it should be pointed out that the advantages, advantages, effects, etc. mentioned in the present application are only examples and are not limiting, and it should not be considered that these advantages, advantages, effects, etc. are necessary for the various embodiments of the present application. In addition, the specific details disclosed above are for the purpose of illustration and ease of understanding, and are not limiting. The above details do not limit the present application to the necessity of adopting the above specific details.

The block diagrams of devices, apparatuses, equipment, and systems involved in the present application are only illustrative examples and are not intended to require or imply that they must be connected, arranged, or configured in the manner shown in the block diagrams. As those skilled in the art will recognize, these devices, apparatuses, equipment, and systems can be connected, arranged, and configured in any manner. Words such as “comprising”, “including”, “having”, etc. are open words, meaning “including but not limited to”, and can be used interchangeably with them. The word “or” and the word “and” as used herein mean “and/or”, and can be used interchangeably with them, unless the context clearly indicates otherwise. The word “such as” as used herein means the phrase “such as but not limited to”, and can be used interchangeably with it.

In addition, as used herein, the “or” used in the enumeration of items starting with “at least one” indicates a separate enumeration, so that, for example, the enumeration of “at least one of A, B, or C” means A or B or C, or AB or AC or BC, or ABC (i.e., A and B and C). Furthermore, the wording “exemplary” does not mean that the described example is preferred or better than other examples.

It should also be pointed out that in the systems and methods of the present application, the various components or steps can be decomposed and/or recombined. These decompositions and/or recombinations should be considered as equivalent solutions of the present application.

Various changes, substitutions, and alterations to the technology described herein can be made without departing from the technology defined by the appended claims. Furthermore, the scope of the claims of the present application is not limited to the specific aspects of the processes, machines, manufactures, compositions of matter, means, methods, and actions described above. Existing or later developed processes, machines, manufactures, compositions of matter, means, methods, or actions that perform substantially the same function or achieve substantially the same result as the corresponding aspects described herein can be utilized. Therefore, the appended claims include within their scope such processes, machines, manufactures, compositions of matter, means, methods, or actions.

The above description of the disclosed aspects is provided to enable any person skilled in the art to make or use the present application. Various modifications to these aspects will be readily apparent to those skilled in the art, and the general principles defined herein can be applied to other aspects without departing from the scope of the present application. Therefore, the present application is not intended to be limited to the aspects shown herein, but is to be accorded the widest scope consistent with the principles and novel features disclosed herein.

The above description has been given for purposes of illustration and description. Furthermore, this description is not intended to limit the embodiments of the present application to the forms disclosed herein. Although several exemplary aspects and embodiments have been discussed above, those skilled in the art will recognize certain variations, modifications, changes, additions, and sub-combinations thereof.

What is claimed is:

1. A conductive component, configured to be disposed on a process cartridge or an image forming apparatus, wherein the process cartridge is detachably installed into a body of the image forming apparatus, an installation direction of the process cartridge is a first direction, the conductive component comprises:
a plurality of conductive members, configured to achieve electrical connection between a power supply member of the image forming apparatus and a load member of the process cartridge, wherein at least one of the load members comprises a roller member;
the conductive member comprises a plurality of electrical contacts, configured to contact the power supply member to connect to a power source;
wherein at least two of the plurality of electrical contacts have different first projection lengths in a second direction;
the first projection length is a length between a first projection position and a second projection position; the first projection position is a projection position of the electrical contact in the second direction; the second projection position is a projection position of a first reference position in the second direction;
the first reference position is any point on a side of the conductive component away from the electrical contact;
wherein the second direction is arranged intersecting the first direction, and the second direction is parallel to an axial direction of the roller member.

2. The conductive component according to claim 1, wherein the first direction is parallel to a connecting line direction between a third projection position and a fourth projection position, the process cartridge comprises a positioning member, the third projection position is a projection position of an axis center of the roller member projected along the second direction, and the fourth projection position is a projection position of the positioning member projected along the second direction; or,
the process cartridge comprises an information processing apparatus, the information processing apparatus comprises a plurality of functional electrical contacts, the first direction is parallel to a sequential arrangement direction of the plurality of functional electrical contacts; or,
the process cartridge comprises an information processing apparatus, the information processing apparatus comprises a functional electrical contact, the first direction is parallel to a connecting line direction between a third projection position and a fifth projection position, the third projection position is a projection position of an axis center of the roller member projected along the second direction, the fifth projection position is a projection position of the functional electrical contact projected along the second direction.

3. The conductive component according to claim 1, wherein projection positions of at least two of the plurality of electrical contacts along the first direction at least partially overlap; or,
projection positions of at least two of the plurality of electrical contacts along the first direction at least partially overlap with a first region;
wherein the first region is a projection region of an outer contour of a roller shaft of the roller member in the first direction.

4. The conductive component according to claim 1, wherein the first projection lengths of the plurality of electrical contacts in the second direction are all different.

5. The conductive component according to claim 1, wherein at least two of the plurality of electrical contacts are arranged spaced apart along the first direction;
the first projection lengths in the second direction of at least two of the plurality of electrical contacts sequentially decrease according to an arrangement order of the corresponding electrical contacts along the first direction.

6. The conductive component according to claim 5, wherein the plurality of electrical contacts comprise a first electrical contact, a second electrical contact, and a third electrical contact, the load members comprise a first load member, a second load member, and a third load member, the first electrical contact is electrically connected to the first load member, the second electrical contact is electrically connected to the second load member, the third electrical contact is electrically connected to the third load member, at least two of the first load member, the second load member, and the third load member are different, and the third electrical contact, the second electrical contact, and the first electrical contact are located on the same side of the conductive component and are arranged sequentially along the first direction.

7. The conductive component according to claim 1, wherein at least one of the plurality of electrical contacts is movably disposed.

8. The conductive component according to claim 1, wherein the second direction is perpendicular to the first direction.

9. A process cartridge, comprising:
a cartridge body;
a load member, wherein at least one of the load members comprises a roller member, and the roller member is rotatably disposed on the cartridge body; and
a conductive component, the conductive component comprising a plurality of conductive members, configured to achieve electrical connection between a power supply member of the image forming apparatus and the load member;
the conductive member comprises a plurality of electrical contacts, configured to contact the power supply member to connect to a power source;
wherein at least two of the plurality of electrical contacts have different first projection lengths in a second direction;
the first projection length is a length between a first projection position and a second projection position; the first projection position is a projection position of the electrical contact in the second direction; the second projection position is a projection position of a first reference position in the second direction;
the first reference position is any point on a side of the conductive component away from the electrical contacts;
wherein the second direction is arranged intersecting the first direction, and the second direction is parallel to an axial direction of the roller member.

10. The process cartridge according to claim 9, wherein the first direction is parallel to a connecting line direction between a third projection position and a fourth projection position, the process cartridge comprises a positioning member, the third projection position is a projection position of an axis center of the roller member projected along the second direction, the fourth projection position is a projection position of the positioning member projected along the second direction; or,
the process cartridge comprises an information processing apparatus, the information processing apparatus comprises a plurality of functional electrical contacts, the first direction is parallel to a sequential arrangement direction of the plurality of functional electrical contacts; or,
the process cartridge comprises an information processing apparatus, the information processing apparatus comprises a functional electrical contact, the first direction is parallel to a connecting line direction between a third projection position and a fourth projection position, the third projection position is a projection position of an axis center of the roller member projected along the second direction, the fourth projection position is a projection position of the functional electrical contact projected along the second direction.

11. The process cartridge according to claim 9, wherein projection positions of at least two of the plurality of electrical contacts along the first direction at least partially overlap; or,
projection positions of at least two of the plurality of electrical contacts along the first direction at least partially overlap with a first region;
wherein the first region is a projection region of an outer contour of a roller shaft of the roller member in the first direction.

12. The process cartridge according to claim 9, wherein the first projection lengths of the plurality of electrical contacts in the second direction are all different.

13. The process cartridge according to claim 9, wherein at least two of the plurality of electrical contacts are arranged spaced apart along the first direction;
the first projection lengths in the second direction of at least two of the plurality of electrical contacts sequentially decrease according to an arrangement order of the corresponding electrical contacts along the first direction.

14. The process cartridge according to claim 13, wherein the plurality of electrical contacts comprise a first electrical contact, a second electrical contact, and a third electrical contact, the load members comprise a first load member, a second load member, and a third load member, the first electrical contact is electrically connected to the first load member, the second electrical contact is electrically connected to the second load member, the third electrical contact is electrically connected to the third load member, at least two of the first load member, the second load member, and the third load member are different, and the third electrical contact, the second electrical contact, and the first electrical contact are located on the same side of the conductive component and are arranged sequentially along the first direction.

15. The process cartridge according to claim 14, wherein the load member comprises at least one of: a roller member, a toner doctor blade, a fixed resistor, a variable resistor; wherein the roller member comprises a developing roller and/or a feeding roller and/or a photosensitive drum.

16. The process cartridge according to claim 15, wherein the first load member comprises a developing roller, the second load member comprises a feeding roller, the third load member comprises a toner doctor blade, the first electrical contact is electrically connected to the developing roller, the second electrical contact is electrically connected to the feeding roller, the third electrical contact is electrically connected to the toner doctor blade; or,
the first load member further comprises a feeding roller, the feeding roller and the developing roller are connected in parallel and then electrically connected to the first electrical contact; or,
the first load member further comprises a feeding roller and a toner doctor blade, the feeding roller, the toner doctor blade, and the developing roller are connected in parallel and then electrically connected to the first electrical contact.

17. The process cartridge according to claim 9, wherein at least one of the plurality of electrical contacts is movably disposed.

18. The process cartridge according to claim 9, wherein the second direction is perpendicular to the first direction.

19. The process cartridge according to claim 9, wherein the conductive component is detachably disposed on the cartridge body; or,
the conductive component is fixedly disposed on the cartridge body; or,
the conductive component is independently disposed from the cartridge body.

20. An image forming apparatus, comprising:
a body, the body comprising an inner side plate, wherein a guide groove is provided on the inner side plate;
a plurality of power supply members;
wherein at least two of contact portions of the plurality of power supply members have different first projection lengths formed in a second direction, and sequentially increase along a first direction;
the first direction is parallel to an extension direction of the guide groove, and the second direction intersects a plane where the inner side plate is located;
wherein the guide groove is configured to guide an installation direction of a conductive component or a process cartridge.
